(19) United States
(12) Patent Application Publication
(10) Pub. No.: US 2021/0238888 A1
(43) Pub. Date: Aug. 5, 2021

(54) DOOR-LOCK DEVICE AND HOUSEHOLD APPLIANCE EQUIPPED WITH SUCH DOOR-LOCK DEVICE

(71) Applicant: BITRON S.P.A., TORINO (IT)

(72) Inventors: Fabrizio PROMUTICO, TORINO (IT); Andrea SACCOCCI, TORINO (IT)

(73) Assignee: BITRON S.P.A., TORINO (IT)

(21) Appl. No.: 17/144,043

(22) Filed: Jan. 7, 2021

(30) Foreign Application Priority Data
Jan. 31, 2020 (IT) 102020000001867

(51) Int. Cl. E05B 57/00; A47L 15/42; D06F 37/42; D06F 39/14; E05C 5/02; E05B 65/00

(52) U.S. Cl. CPC E05B 57/00; A47L 15/4259; E05B 65/00; D06F 39/14; E05C 5/02; D06F 37/42

(57) ABSTRACT

The present invention relates to a door-lock device (1) for an household appliance, such as a washing machine, a dishwasher and the like, having a door provided with a prong (P), wherein said door-lock device (1) comprises a containment casing (2), a blocking assembly (4), arranged in said containment envelope (2), and having a hook (44), intended to engage with the prong (P) when the household appliance door is closed, wherein said hook (44) is configured to translate when engaging with said prong (P), characterized in that said blocking assembly (4) comprises at least one or more rolling members (46, 47), associated to said hook (44) and arranged to roll so as to allow translational motion of said hook (44).

The present invention also relates to a household appliance, such as a washing machine, a dishwasher and the like.

The present invention relates to a door-lock device and a household appliance equipped with such door-lock device.

### FIELD OF THE INVENTION

More specifically, the invention relates to a door-lock device of the aforementioned type, of the type intended for locking a door of a household appliance, such as that of a washing machine or a dishwasher, also provided with a self-closing function (“pull”), by means of which when closing, the door-lock device makes it easier to close the door.

In the following, the description will be directed to the application of the door-lock device in a washing machine, but it is quite clear that it should not be considered limited to this specific use.

### PRIOR ART

As it is well known, there are currently various types of door-lock devices for the secure locking of a door of a washing machine, a dishwasher, and a household appliance in general.

In particular, there are also door-lock devices that allow the door to be pulled when it is closed. An example of this type of device is described in the European patent EP 1304436 B1 owned by the applicant, which, however, has some technical problems.

In particular, among the technical problems found in the applications of door-lock devices of the type referred to according to the prior art, there are some guides, in which some parts of the assembly slide over others, in the movements of the hook to which the pulled back prong of the door is locked. This configuration, in addition to creating mechanical noise phenomena, particularly unwelcome in the market, causes the so-called “stick and slit” phenomena, according to which, when for different reasons, which can be for example the load compensation or the like, in some parts an excess pressure is created due to contact, the movement of the entire assembly can compensate itself and block, and then be released immediately, creating problems in the operation of the device.

### SCOPE OF THE INVENTION

In the light of the above, it is therefore an object of the present invention to propose a door-lock device capable of overcoming the technical limits of those of the prior art.

Another object of the invention is to propose a door-lock device that allows movement avoiding or limiting the sliding of parts.

### OBJECT OF THE INVENTION

It is therefore specific object of the invention a door-lock device for an household appliance, such as a washing machine, a dishwasher and the like, having a door provided with a prong, wherein said door-lock device comprises a containment casing, a blocking assembly, arranged in said containment envelope, and having a hook, intended to engage with the prong when the household appliance door is closed, wherein said hook is configured to translate when engaging with said prong, characterized in that said blocking assembly comprises at least one or more rolling members, associated to said hook and arranged to roll so as to allow translational motion of said hook.

Always according to the invention, said containment casing may comprise inner walls on which said one or more rolling members roll when said hook translates.

Still according to the invention, said containment casing may comprise one or more gear racks and said one or more rolling members may comprise one or more toothed wheels, each engaged with a respective gear rack.

Advantageously according to the invention, said containment casing may have at least one guide, and said hook may comprise one or more lateral relieves, each slidingly arranged on one respective of said guides, so as to allow said hook to translate along said guides.

Further according to the invention, said blocking assembly may comprise a return spring, having one or more arms, each one engaged with a respective lateral relief of said hook, wherein said return spring is arranged so as to translate said hook when said prong interferes with said hook.

Preferably according to the invention, said hook may have a transverse channel, and said blocking assembly may comprise a bar inserted in said transverse channel, such that said bar remains free in rotation with respect to said hook, wherein one or more rolling members are keyed to the ends of said bar.

Always according to the invention, said blocking assembly may comprise a support frame, arranged in said containment casing, and having a seat with an internal guide surface, and said hook may have a shaped portion interfering with said guide surface of said seat, wherein said guide surface and said shaped portion are shaped in such a way to allow the rotation of said hook when it is engaged with said prong and is moved by said prong.

Still according to the invention, said containment casing may have an opening, in which the prong of the door of the household appliance is insertable, said one or more gear racks may be oriented in a direction parallel to the movement of the prong of the door of the household appliance, when it is inserted in said opening.

Advantageously according to the invention, said blocking assembly may comprise a slider, arranged so as to assume an unlocking position and a locking position, wherein it interferes with said hook, to prevent the opening of the door when the prong is engaged with said hook, and a pushing spring, arranged so as to push said slider to assume said locking position.

Further according to the invention, said slider may have an inclined surface, which interferes with said hook when said slider is in said locking position, so as to prevent the rotation and the opening of the door when said prong is engaged with said hook.

Preferably according to the invention, said door-lock device may comprise an activation module comprising a locking pin capable of assuming, on command, a retracted position and an extracted position, and said slider may comprise a relief, wherein said slider is arranged so that, when it assumes said unlocking position, said relief interferes with said locking pin, keeping it in the retracted position, and, when it assumes said locking position, said relief does not interfere with said locking pin, which is thus free to assume said extracted position, thus interfering with said slider locking it.

It is further object of the present invention a household appliance, such as a washing machine, a dishwasher and the like, comprising a frame, a door hinged to said frame, provided with a prong, and a door-lock device, as described above, for interfering with said prong to close and lock said door of said household appliance.

### BRIEF DESCRIPTION OF THE DRAWINGS

The present invention will be now described, for illustrative but not limitative purposes, according to its preferred embodiments, with particular reference to the figures of the enclosed drawings, wherein:

FIG. 1 illustrates a front perspective view of the door-lock device according to the present invention;

FIG. 2 illustrates a rear perspective view of the door-lock device according to FIG. 1;

FIG. 3 illustrates an exploded view of the door-lock device according to FIG. 1;

FIG. 4 illustrates a first section of the door-lock device according to FIG. 1;

FIG. 5 illustrates a second section of the door-lock device according to FIG. 1;

FIG. 6 illustrates a third section of the door-lock device according to FIG. 1;

FIG. 7A illustrates a first section of the door-lock device according to the present invention in the door open state;

FIG. 7B illustrates a second section of the door-lock device according to the present invention, in the door open state;

FIG. 7C illustrates a first section of the door-lock device according to the present invention, in the state of the door during the engagement of a prong with a rotating hook;

FIG. 7D illustrates a second section of the door-lock device according to the present invention of the door state during the engagement of a prong with a rotating hook;

FIG. 7E illustrates a first section of the door-lock device according to the present invention, in the state of closed and locked door;

FIG. 7F illustrates a second section of the door-lock device according to the present invention, in the state of closed and locked door;

FIG. 8A illustrates the door-lock device according to the present invention when the hook pulls the prong to close the door;

FIG. 8B shows the door-lock device of FIG. 8A when it is in the end-of-stroke position; and

FIG. 8C shows the door-lock device in the locked position when there is an attempt to open the door.

### DETAILED DESCRIPTION OF THE DRAWINGS

In the various figures, similar parts will be indicated by the same reference numbers.

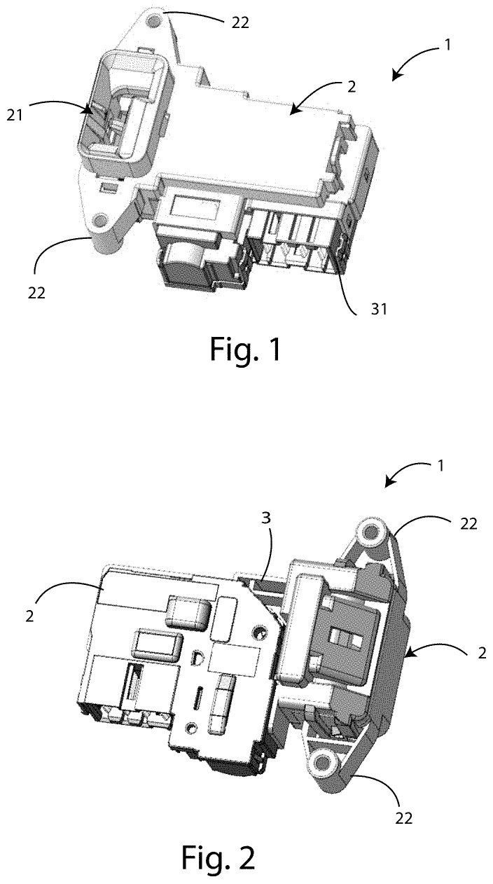

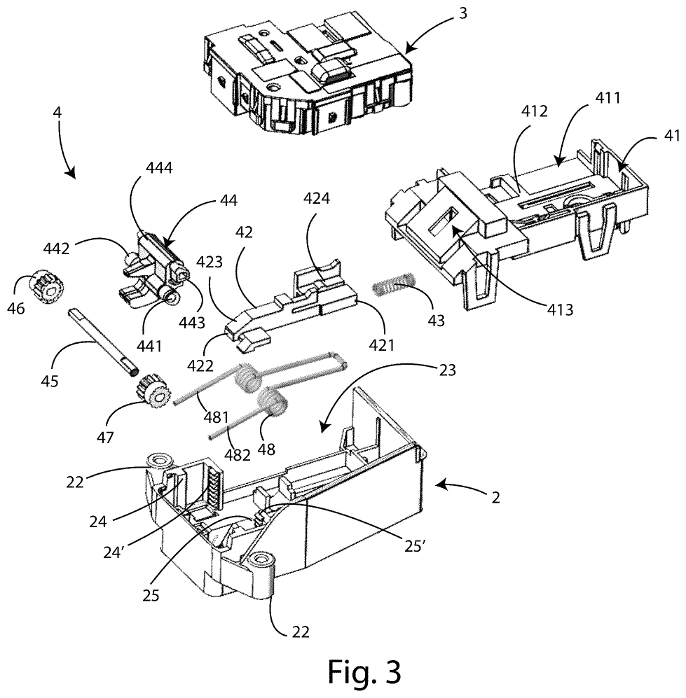

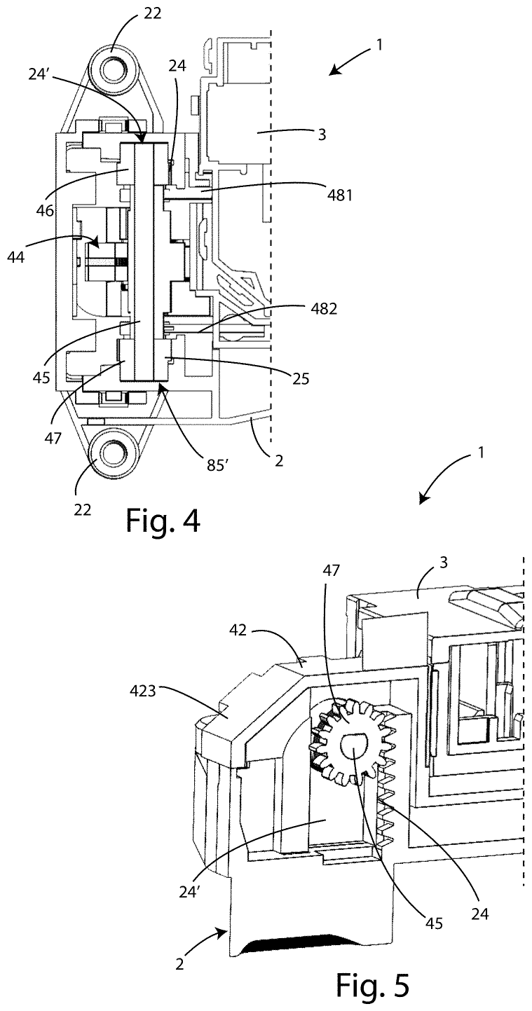

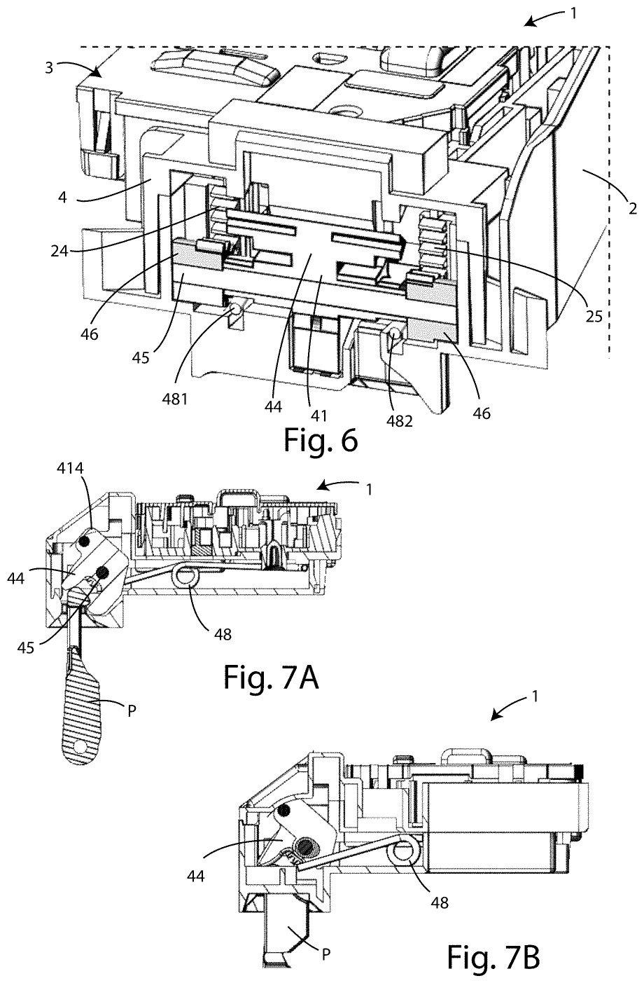

With reference to FIGS. 1-6, a door-lock device according to the present invention can be seen, indicated as a whole with the numerical reference 1.

In particular, the door-lock device 1 essentially comprises a containment casing 2, an activation module 3, housed inside said containment casing 2, and a blocking assembly 4, also housed in said containment casing 2.

The containment casing 2 has an opening 21, into which the prong of a door of a household appliance (not shown in the figures), such as a washing machine, a dishwasher, can be inserted.

Furthermore, the containment casing 2 also has coupling flanges 22, arranged in the embodiment at issue near said opening 21, for coupling the door-lock device 1 to the frame of the household appliance. More specifically, the coupling flanges 22 allow the coupling of the lock-door device 1 by means of screws (not shown in the figure).

The containment casing 2 also comprises a compartment 23, for housing the blocking assembly 4 and the activation module 3. In particular, the blocking assembly 4 is interposed between the containment casing 2 and the activation module 3.

Furthermore, in proximity of said opening 21, in the compartment 23, two gear racks are provided, respectively indicated with the numerical references 24 and 25, oriented vertically, or in a direction parallel to the movement of the prong of the door of the household appliance, when it is inserted into the opening 21 when closing the door itself.

Said gear racks 24 and 25 are obtained for example by molding on internal walls in the containment casing 2, but they can also be obtained by other methods. In addition, in other embodiments, the door-lock device 1 can provide a different number of gear racks, for example, one or more than two. The function of said gear racks 24 and 25 will be better described below.

Furthermore, the containment casing 2 also comprises grooves which form a pair of guides 24′ and 25′, always obtained in the containment casing 2, each arranged in proximity to a respective gear rack 24 and 25, whose operation will be better defined below.

The activation module 3 comprises connection electrodes 31 for its functional connection with the logic control unit (not shown in the figures) of the household appliance, in which the door-lock device 1 is installed.

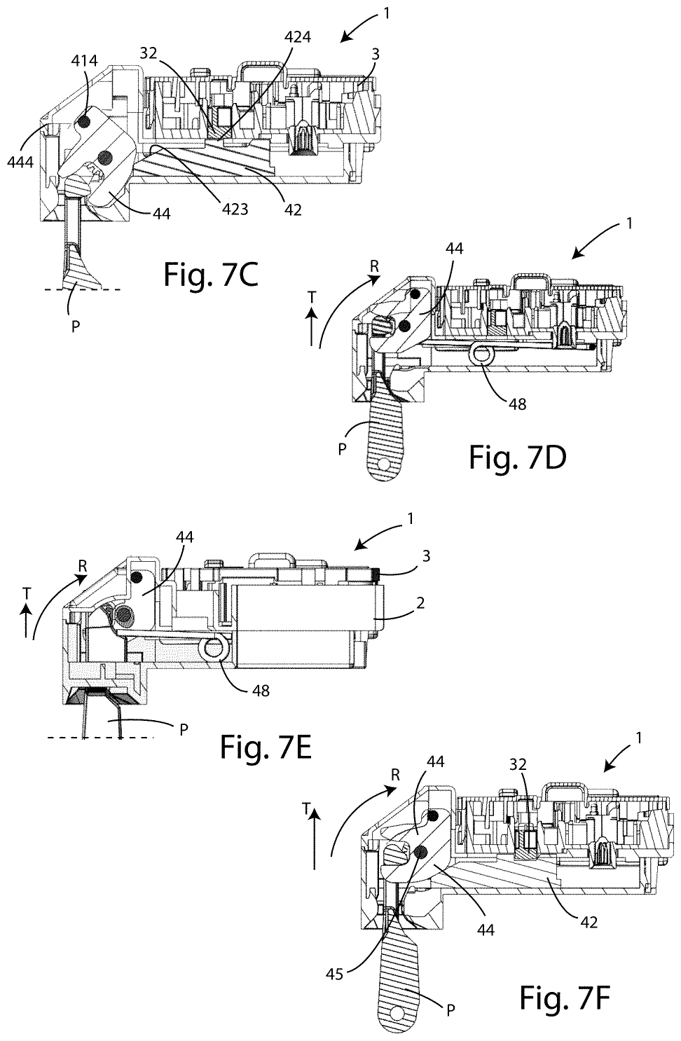

Said activation module 3 also comprises a locking pin (see FIGS. 7C, and 7F) capable of assuming, on command, a retracted position and an extracted position.

The blocking assembly 4 comprises a support frame 41, inserted in said compartment 23, having a housing 411, provided with an upper surface 412. The activation module 3, is arranged in said housing 411, so that said locking pin is arranged facing said housing 411.

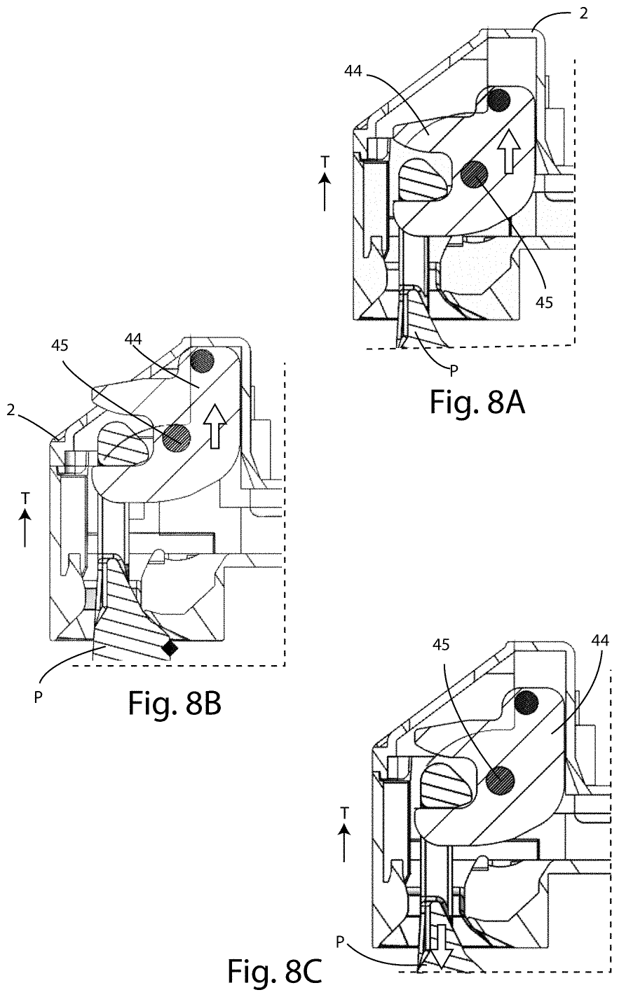

Furthermore, said support frame 41 also has a seat 413, having an internal guide surface 414 (which is shown in FIG. 8A).

The blocking assembly 4 comprises a slider 42, having a first end 421 and a second end 422.

The slider 42 is arranged to slide on said upper surface 412 of said housing 411. Furthermore, the slider 42 has, at the second end 422, an inclined surface 423, the function of which will be better described below.

The slider 42 also comprises a relief 424 and is configured to assume an unlocking position, in which the relief 424 interferes with the locking pin, forcing it to remain in the retracted position, and a locking position, in which the relief 424 does not interfere with the locking pin, which is thus free to assume, if necessary, and on command, said extracted position, thus interfering with said slider 42, blocking it in position.

The blocking assembly 4 also comprises a pushing spring 43, interposed between said slider 42 and said support frame 41, which forces the slider 42 to assume the locking position.

Said blocking assembly 4 further comprises a rotating hook 44, intended to engage with the prong of the household appliance door, and arranged in correspondence with said opening 21 within said seat 413.

Furthermore, the rotating hook 44 has lateral projections, indicated respectively by the numerical references 441 and 442, each slidably arranged on a respective of said guides 24′ and 25′, so as to allow the rotating hook 44 to translate along said guides 24′ and 25′. The rotating hook 44 also has a transverse channel 443 and a shaped portion 444, which interferes with said guide surface 414 of said seat 413, in which said guide surface 414 is such as to allow, as will be better described below, the rotation of said rotating hook 44 when it is engaged and is moved by the prong of the household appliance door.

Furthermore, when the slider 42 is in said locking position, the inclined surface 423 interferes with said rotating hook 44, to prevent the opening of the door when the prong P is engaged with the rotating hook 44 itself.

The inclination of the inclined surface 423 allows an easier interference with the rotating hook 44, when the slider 42 is in said locking position.

The blocking assembly 4 also comprises a bar 45, inserted in the transverse channel 443, such that said bar 45 remains idle with respect to said rotating hook 44. When said bar 45 is inserted into said transverse channel 443, the ends project laterally from said rotating hook 44.

Furthermore, the blocking assembly 4 also comprises a pair of toothed wheels 46 and 47, each respectively keyed to the ends of said bar 45. Said toothed wheels 46 and 47 are arranged so as to engage each with a respective gear rack 24 and 25 of said containment casing 2. In this way, the assembly constituted by of the rotating hook 44, the bar 45, and the toothed wheels 46 and 47 are movable so as to translate the rotating hook 44 along said guides 24′ and 25′, while the toothed wheels 46 and 47 rotate engaged on the gear racks 24 and 25, thanks to the idle rotation of said bar 45 in the channel 443.

In other embodiments, the gear racks 24 and 25 can be replaced by simple internal walls, even smooth ones, while the toothed wheels 46 and 47 can be simple rolling members, such as possibly rubber-coated wheels, capable of rolling on the internal walls of said containment casing 2, which therefore act as guides in the movement by translation of the rotating hook 44.

The blocking assembly 4 finally comprises a torsion type return spring 48, interposed between said containment casing 2 and said support frame 41, having two arms 481 and 482, each engaged with one of said lateral projections 441 and 442 of the rotating hook 44, and arranged so as to cause the movement of said rotating hook 44 in the direction indicated by the arrow T, i.e., parallel to the movement of said prong, when it is inserted into the opening 21.

The operation of the door-lock device 1 described above is as follows.

When the household appliance door is open (see FIGS. 7A, 7B and 7C), the door prong, indicated by the letter P, is extracted and the rotating hook 44 is in a rotated position.

Furthermore, said slider 42 is in said unlocking position and the pushing spring 43 (not shown in the above figures) is compressed between a first end 421 of said slider 42 and the support frame 41.

Furthermore, still in this configuration, the slider 42 does not interfere with the rotating hook 44 and the relief 424 interferes with the locking pin, which is indicated in the figures with the numerical reference 32.

In this way, irrespective of the commands of the logical control unit of the household appliance, which the door-lock device 1 is installed in, said locking pin 32 cannot pass from said retracted position to said extracted position.

On the other hand, when the door is closed, the prong P is inserted into said opening 21 of said containment casing 2, and interferes with said rotating hook 44 (see FIGS. 7D, 7E, and 7F).

In the above-mentioned closing step, the force exerted by the prong P on the rotating hook 44 causes the interaction between said shaped portion 444, and said internal guide 414, which in turn implies the rotation of the rotating hook 44 according to the arrow R.

Subsequently, once the rotating hook 44 cannot rotate further, the torsion return spring 48 causes a thrust on the rotating hook 44, acting by means of its arms 481 and 482, respectively on the lateral reliefs 441 and 442 of the rotating hook 44 itself.

At the same time, the rotating hook 44 is translated, obtaining the “pull” effect of the door-lock device 1 on the prong P and, therefore, on the door of the household appliance. In said return step, the toothed wheels 46 and 47 rotate and roll on the respective gear racks 24 and 25.

In this way, there is a translation without the sliding of mechanical parts, avoiding any “stick and slit” phenomenon.

Furthermore, the slider 42 passes from said unlocking position to said locking position, so that the inclined surface 423 interferes with the rotating hook 44, locking it in position and preventing its rotation in the opposite direction to the arrow R, or preventing the opening of the door.

Subsequently, following the command of the central control unit, the locking pin 32 can pass from said retracted position to said extracted position, thus blocking the slider 42 in position, which cannot return, except following a command from the central control unit of the household appliance, from said locking position to said unlocking position. Therefore, in this configuration shown in said FIGS. 7D, 7E, and 7F, the door is closed and locked.

Referring also to FIGS. 8A, 8B and 8C, it is possible to observe the translational motion of the rotating hook 44 accompanied by the rolling of the toothed wheels 46 and 47 on the respective gear racks 24 and 25, so as to avoid the sliding of parts. As can be observed in particular in FIG. 8C, if there is an attempt to open the door, the rotation of the rotating hook 441 would be prevented by the slider 42, held in the locking position by the pin 32.

### ADVANTAGES

An advantage of the present invention is that of having a particularly compact assembly, and therefore of saving space and sizes of the door-lock.

A further advantage of the present invention is that of limiting members sliding by contact, obtaining a considerable reduction of the possible “stick and slit” phenomenon.

The present invention has been described for illustrative but not limitative purposes, according to its preferred embodiments, but it is to be understood that modifications and/or changes can be introduced by those skilled in the art without departing from the relevant scope as defined in the enclosed claims.

1. A door-lock device (1) for a household appliance, such as a washing machine, a dishwasher and the like, having a door provided with a prong (P), wherein said door-lock device (1) comprises
a containment casing (2),
a blocking assembly (4),
arranged in said containment envelope (2), and
having a hook (44), intended to engage with the prong (P) when the household appliance door is closed, wherein said hook (44) is configured to translate when engaging with said prong (P),
characterized in that said blocking assembly (4) comprises at least one or more rolling members (46, 47), associated to said hook (44) and arranged to roll so as to allow translational motion of said hook (44).

2. The door-lock device (1) according to claim 1, characterized in that said containment casing (2) comprises inner walls on which said one or more rolling members (46, 47) roll when said hook (44) translates.

3. The door-lock device (1) according to claim 1, characterized
in that said containment casing (2) comprises one or more gear racks (24, 25) and in that said one or more rolling members comprise one or more toothed wheels (46, 47), each engaged with a respective gear rack (24, 25).

4. The door-lock device (1) according to claim 1, characterized
in that said containment casing (2) has at least one guide (24′, 25′), and
in that said hook (44) comprises one or more lateral relieves (441, 442), each slidingly arranged on one respective of said guides (24′, 25′), so as to allow said hook (44) to translate along said guides (24′, 25′).

5. The door-lock device (1) according to claim 4, characterized in that said blocking assembly (4) comprises a return spring (48), having one or more arms (481, 482), each one engaged with a respective lateral relief (441, 442) of said hook (44),
wherein said return spring (48) is arranged so as to translate said hook (44) when said prong (P) interferes with said hook (44).

6. The door-lock device (1) according to claim 1, characterized
in that said hook (44) has a transverse channel (443), and
in that said blocking assembly (4) comprises a bar (45) inserted in said transverse channel (443), such that said bar (45) remains free in rotation with respect to said hook (44), wherein one or more rolling members (46, 47) are keyed to the ends of said bar (45).

7. The door-lock device (1) according to claim 1, characterized
in that said blocking assembly (4) comprises a support frame (41), arranged in said containment casing (2), and having a seat (413) with an internal guide surface (414), and
in that said hook (44) has a shaped portion (444) interfering with said guide surface (414) of said seat (413),
wherein said guide surface (414) and said shaped portion (444) are shaped in such a way to allow the rotation of said hook (44) when it is engaged with said prong (P) and is moved by said prong (P).

8. The door-lock device (1) according to claim 3, characterized
in that said containment casing (2) has an opening (21), in which the prong (P) of the door of the household appliance is insertable,
in that said one or more gear racks (24, 25) are oriented in a direction parallel to the movement of the prong (P) of the door of the household appliance, when it is inserted in said opening (21).

9. The door-lock device (1) according to claim 1, characterized in that said blocking assembly (4) comprises
a slider (42), arranged so as to assume
an unlocking position and
a locking position, wherein it interferes with said hook (44), to prevent the opening of the door when the prong (P) is engaged with said hook (44), and
a pushing spring (43), arranged so as to push said slider (42) to assume said locking position.

10. The door-lock device (1) according to claim 9, characterized in that said slider (42) has an inclined surface (423), which interferes with said hook (44) when said slider (42) is in said locking position, so as to prevent the rotation and the opening of the door when said prong (P) is engaged with said hook (44).

11. The door-lock device (1) according to claim 9, characterized
in that it comprises an activation module (3) comprising a locking pin (32) capable of assuming, on command, a retracted position and an extracted position, and
in that said slider (42) comprises a relief (424), wherein said slider (42) is arranged so that, when it assumes said unlocking position, said relief (424) interferes with said locking pin (32), keeping it in the retracted position, and, when it assumes said locking position, said relief (424) does not interfere with said locking pin (32), which is thus free to assume said extracted position, thus interfering with said slider (42) locking it.

12. A household appliance, such as a washing machine, a dishwasher and the like, comprising
a frame,
a door hinged to said frame, provided with a prong (P), and
a door-lock device (1), according to any one of the preceding claims, for interfering with said prong (P) to close and lock said door of said household appliance.
